(19) United States
(12) Patent Application Publication
(10) Pub. No.: US 2019/0162213 A1
(43) Pub. Date: May 30, 2019

(54) COMBINED FIXING APPARATUS AND ALARM DEVICE

(71) Applicant: SITERWELL ELECTRONICS CO., LIMITED, Ningbo (CN)

(72) Inventor: Jiejun WANG, Ningbo City (CN)

(21) Appl. No.: 16/035,962

(22) Filed: Jul. 16, 2018

(30) Foreign Application Priority Data
Nov. 27, 2017 (CN) 201711207450.8

(51) Int. Cl. F16B 2/06; F16B 11/00; G08B 17/113

(52) U.S. Cl. CPC F16B 2/065; F16B 2001/0035; G08B 17/113; F16B 11/008

(57) ABSTRACT

The present invention is applicable to the field of security and protection, and provides a combined fixing apparatus and an alarm device. The combined fixing apparatus includes: a first fixing part that can be fixed to an installation surface in a punching-free manner; and a second fixing part that can be fastened to an installation; wherein the first fixing part and the second fixing part are provided with detachable structures cooperating with each other and reliably connecting the first fixing part to the second fixing part respectively. The first fixing part and the second fixing part are detachably connected, which facilitates assembly and disassembly. Moreover, the first fixing part is fixed in a punching-free manner, which can avoid the damage to the installation surface and can reduce labor costs of installation, improving the working efficiency.

### TECHNICAL FIELD

The present invention relates to the field of security and protection, and in particular, to a combined fixing apparatus and an alarm device.

### BACKGROUND ART

Existing installations, such as alarms, are usually installed by punching. Specifically, a hole is punched on an installation surface (such as a ceiling or wall) first. Then a hanging board (a connecting plate having two ends being plate-shaped connectors) is installed in the hole by using a plastic expansion rubber plug, and a screw is inserted in the plastic expansion rubber plug to fix the hanging board. Next, an alarm body is fixed onto the hanging board by using a snap mechanism.

In an actual operation, if the above installation manner is adopted, manual punching is required in the process of installation, which not only needs to damage an installation surface but also needs to implement the process manually, thus having high labor costs.

### SUMMARY OF THE INVENTION

Embodiments of the present invention provide a combined fixing apparatus, aimed at solving the problem existing in the prior art that manual punching is required in the process of installation, which not only needs to damage an installation surface but also needs to implement the process manually, thus having high labor costs.

The embodiments of the present invention are implemented as follows: a combined fixing apparatus, including:

a first fixing part that can be fixed to an installation surface in a punching-free manner; and

a second fixing part that can be fastened to an installation;

wherein the first fixing part and the second fixing part are provided with detachable structures cooperating with each other and reliably connecting the first fixing part to the second fixing part respectively.

The embodiments of the present invention further provide an alarm device, including:

an alarm; and

a combined fixing apparatus that can be fixedly connected to the alarm, configured to install the alarm on an installation surface;

wherein the combined fixing apparatus includes:

a first fixing part that can be fixed to the installation surface in a punching-free manner; and

a second fixing part that can be fastened to an installation;

wherein the first fixing part and the second fixing part are provided with detachable structures cooperating with each other and reliably connecting the first fixing part to the second fixing part respectively.

The combined fixing apparatus provided in the embodiments of the present invention detachably connects a first fixing part to a second fixing part, facilitating assembly and disassembly of installations, and fixes the first fixing part in a punching-free manner, which can avoid the damage to an installation surface and can reduce labor costs of the installation, improving the working efficiency.

### BRIEF DESCRIPTION OF THE DRAWINGS

FIG. 1 is a schematic structural diagram of an alarm device according to an embodiment of the present invention;

FIG. 2 is a schematic structural diagram of a combined fixing apparatus according to Embodiment 1 of the present invention;

FIG. 3 is a schematic structural diagram of a first fixing part according to Embodiment 1 of the present invention;

FIG. 4 is a schematic structural diagram of a first fixing part including an adhesion layer according to Embodiment 1 of the present invention;

FIG. 5 is a schematic structural diagram of a second fixing part according to Embodiment 1 of the present invention;

FIG. 6 is a schematic structural diagram of a second fixing part including a magnet part according to Embodiment 1 of the present invention;

FIG. 7 is a schematic structural diagram of a combined fixing apparatus according to Embodiment 2 of the present invention;

FIG. 8 is a schematic structural diagram of a first fixing part according to Embodiment 3 of the present invention;

FIG. 9 is a schematic structural diagram of a second fixing part according to Embodiment 3 of the present invention; and

FIG. 10 is a schematic structural diagram of a combined fixing apparatus according to Embodiment 4 of the present invention.

### DETAILED DESCRIPTION

To make the objectives, technical solutions, and advantages of the present invention more comprehensible, the present invention is described below in further detail with reference to the accompanying drawings and embodiments. It should be understood that specific embodiments described here are merely used to explain the present invention but are not used to limit the present invention.

The combined fixing apparatus provided in the embodiments of the present invention detachably connects a first fixing part to a second fixing part, facilitating assembly and disassembly of installations, and fixes the first fixing part in a punching-free manner, which can avoid the damage to an installation surface and can reduce labor costs of the installation, improving the working efficiency. The present invention is described in the following by using specific embodiments.

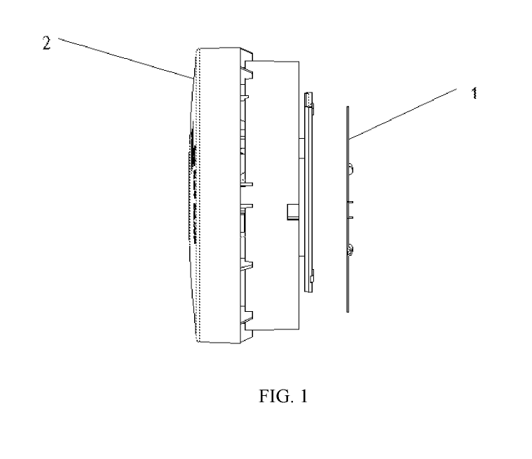

Referring to FIG. 1, the combined fixing apparatus 1 provided in the embodiment of the present invention includes a first fixing part that can be fixed to an installation surface in a punching-free manner; and a second fixing part that can be fastened to an installation. The first fixing part and the second fixing part are provided with detachable structures cooperating with each other and reliably connecting the first fixing part to the second fixing part respectively.

In the embodiment of the present invention, the first fixing part is detachably connected to the second fixing part, facilitating assembly and disassembly of installations, and the first fixing part is fixed in the punching-free manner, which can avoid the damage to the installation surface and can reduce labor costs of the installation, improving the working efficiency.

The installation surface may be an object such as a ceiling or a wall. The installation may be an alarm or the like.

In the embodiment of the present invention, the first fixing part and the second fixing part can be connected by using detachable structures, as described in detail as follows:

In Embodiment 1 of the present invention, an implementation manner in which a first fixing part 10 and a second fixing part 20 can be connected by means of clamping after rotation is provided.

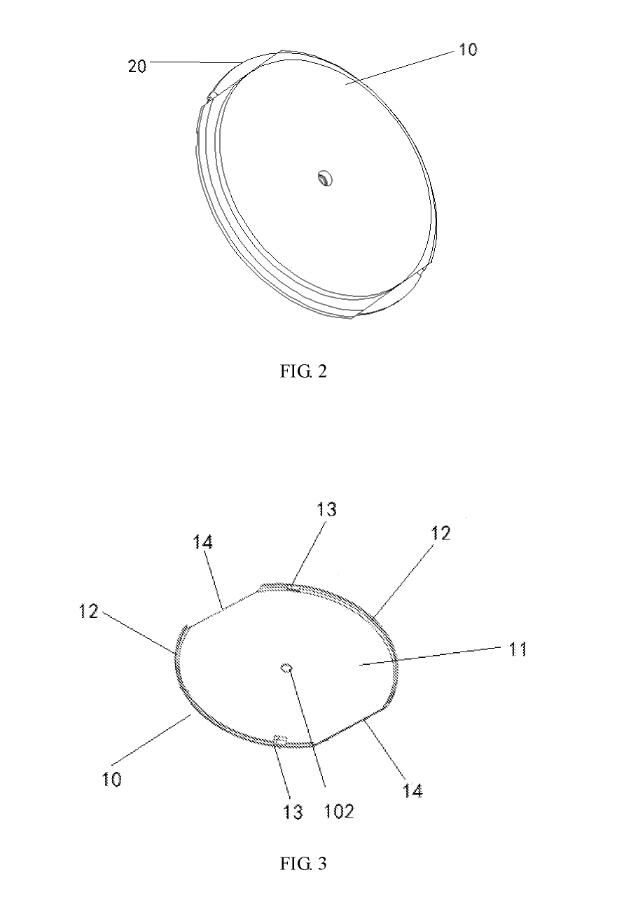

Referring to FIG. 2 to FIG. 5, the first fixing part 10 includes: a first flat plate portion 11. Edges of the first flat plate portion 11 are provided with borders 12 and snaps 13 disposed on the borders 12.

In Embodiment 1 of the present invention, the first fixing part 10 further includes operable notches 14 disposed oppositely. After the second fixing part 20 is embedded into the borders 12 of the first fixing part 10, by gripping the positions of the operable notches 14 and rotating the second fixing part 20, the first fixing part 10 and the second fixing part 20 rotate relatively to form clamping.

Further, the borders 12 form two borders 12 disposed oppositely under the influences of the operable notches 14 of the first fixing part 10.

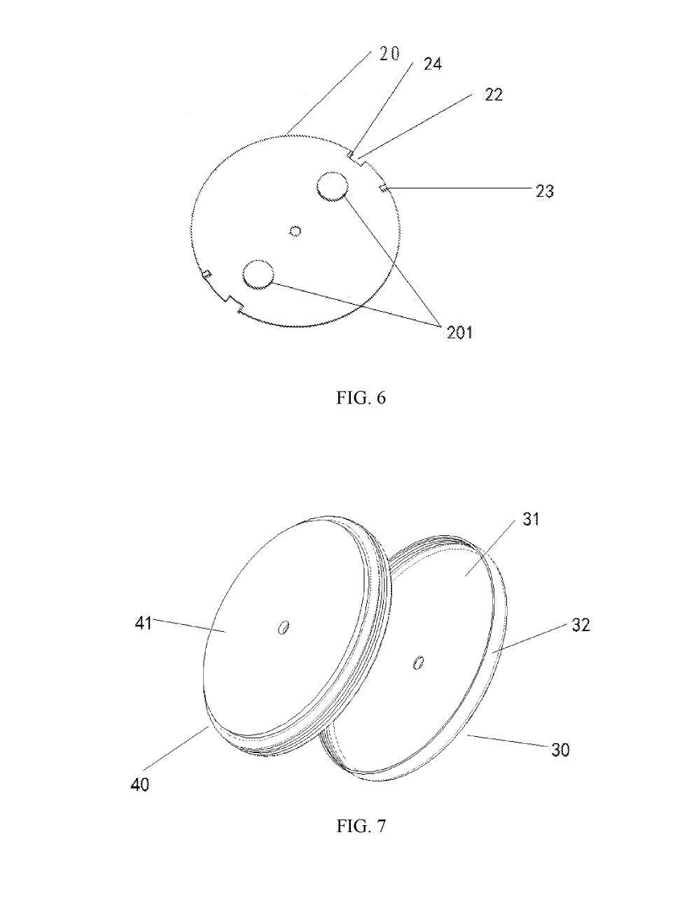

Referring to FIG. 3, FIG. 5, and FIG. 6, the second fixing part 20 includes: a second flat plate portion 21. The second flat plate portion 21 is provided with notches 22 opposite the snaps 13, such that the second flat plate portion 21 can be attached to the first flat plate portion 11 and is embedded into the borders 12, and the first fixing part 10 and the second fixing part 20 rotate relatively to form clamping.

In Embodiment 1 of the present invention, the second fixing part 20 further includes a first limit structure 23. The first limit structure 23 is disposed on a screw-in side of the second fixing part 20, and can be configured to limit the quantity of screw-in of the second fixing part 20 screwed in the borders 12 of the first fixing part 10. The first limit structure 23 is higher than the snaps 13. Therefore, when the second fixing part 20 rotates to the position where the first limit structure 23 comes into contact with the snaps 13, the first limit structure 23 can stop the snaps 13 from passing and then stop the second fixing part 20 from rotating, to form locked clamping.

In Embodiment 1 of the present invention, the second fixing part 20 further includes a second limit structure 24. The second limit structure 24 is disposed on a side opposite the screw-in side, and is formed by extending outwardly from an edge on one side of the notches 22. The second limit structure 24 is higher than the snaps 13. Therefore, when the second fixing part 20 needs to be removed from the borders 12 of the first fixing part 10, the second fixing part 20 can be rotated to the second limit structure 24, such that the notches 22 disposed on the second fixing part 20 correspond to the snaps 13 on the first fixing part 10, and the second fixing part 20 is separated from the first fixing part 10. By setting the second limit structure 24, the notches 22 can be found quickly, such that the second fixing part 20 is separated from the first fixing part 10 quickly, which is easy to disassemble.

In Embodiment 2 of the present invention, an implementation manner in which a first fixing part 30 and a second fixing part 40 can be connected by thread is provided.

Referring to FIG. 7, as an implementation manner of Embodiment 2 of the present invention, the first fixing part 30 includes a first planar member 31 and a side wall 32 that is located at an edge of the first planar member 31 and extends circumferentially towards the direction where the first fixing part 30 is connected to the second fixing part 40. An inner surface of the side wall 32 is provided with threads.

The second fixing part 40 includes a second planar member 41. An outer side wall of the second planar member 41 is provided with threads matching the threads disposed on the inner surface of the side wall 32. When it is necessary to connect the first fixing part 30 to the second fixing part 40, the outer side wall of the second planar member 41 contacts the first planar member 31 and matches the threads disposed on the side wall 32 of the first planar member 31 by means of rotation, thus connecting the first fixing part 30 to the second fixing part 40 by thread, being easy to disassemble. The fixing parts can be removed and replaced at any time, and the structure is simple, easy to install, and low in costs.

The first fixing part 30 and the second fixing part 40 provided in Embodiment 2 of the present invention can be replaced with each other. That is, the first fixing part 30 can be connected to the installation, and the second fixing part 40 can be connected to the installation surface.

In Embodiment 3 of the present invention, an implementation manner in which a first fixing part 50 and a second fixing part 60 can be connected by means of insertion and locking is provided.

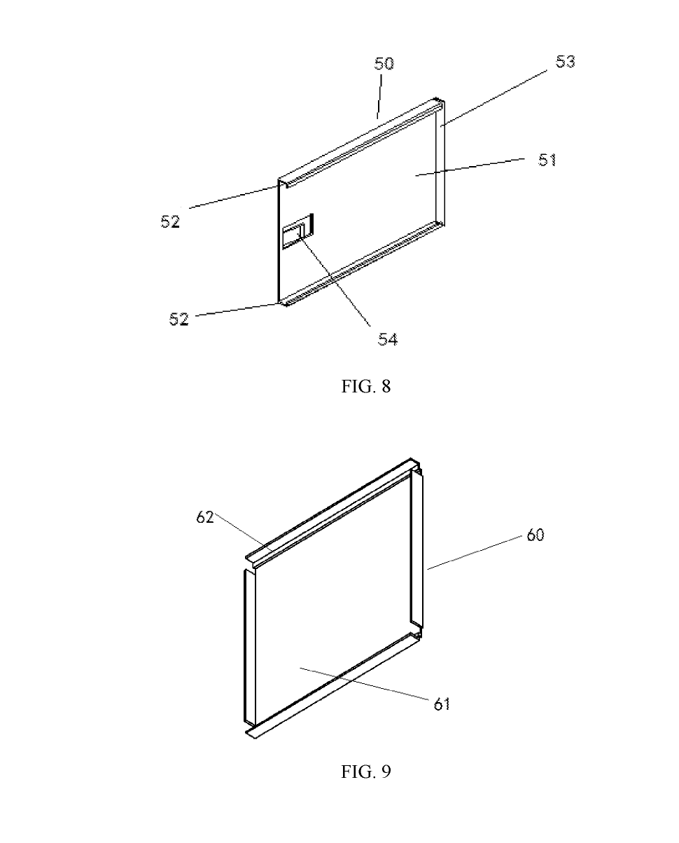

Referring to FIG. 8, the first fixing part 50 includes a first flat plate structure 51, sliding rails 52 that are disposed oppositely on two sides of the first flat plate structure 51 and extend towards a thickness direction, a baffle structure 53 configured to limit a moving distance of the second fixing part 60, and a stopping sheet 54 that is disposed on the first flat plate structure 51 and configured to lock the second fixing part after the second fixing part 60 slides into the sliding rails 52 of the first fixing part 50 and comes into contact with the baffle structure 53.

Referring to FIG. 9, the second fixing part 60 includes a second flat plate structure 61, and step structures 62 disposed oppositely on two sides of the second flat plate structure 61 and configured to slide in cooperation with the sliding rails 52.

When it is necessary to connect the second fixing part 60 to the first fixing part 50, the second fixing part 60 starts to slide along the sliding rails 52 from one side provided with the stopping sheet 54, till it slides to the position of the baffle structure 53. As the stopping sheet 54 is elastic, the stopping sheet 54 will be compressed to a horizontal state under the action of the second fixing part 60 when the second fixing part 60 passes, and resumes the original state when the second fixing part 60 passes completely. In this case, the stopping sheet 54 is attached to one side of the second fixing part 60, and the second fixing part 60 is fixed between the stopping sheet 54 and the baffle structure 53, thus connecting the first fixing part 50 and the second fixing part 60.

In Embodiment 3 of the present invention, in an actual application, the first fixing part 50 and the second fixing part 60 can be replaced with each other. That is, the first fixing part 50 can be connected to the installation, and the second fixing part 60 can be connected to the installation surface.

In Embodiment 4 of the present invention, an implementation manner in which a first fixing part 70 and a second fixing part 80 can be connected by means of clamping is provided.

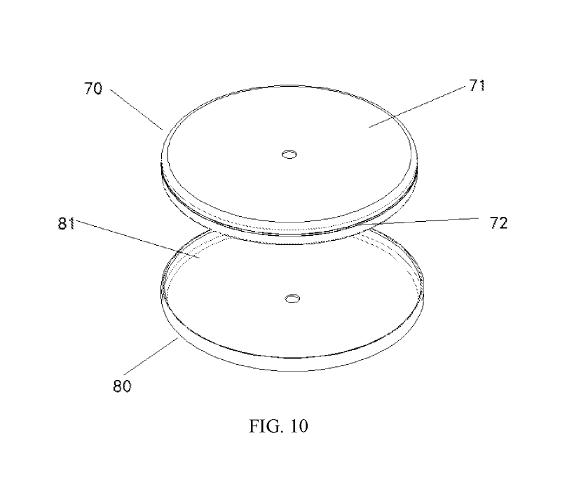

Referring to FIG. 10, in Embodiment 4 of the present invention, the first fixing part 70 includes: a platform structure 71. A side wall of the platform structure 71 is provided with a snap ring 72. The second fixing part 80 includes an accommodating slot 81. The accommodating slot 81 can accommodate the platform structure 71, and is clamped together with the platform structure 71 by using the snap ring 72.

The platform structure 71 can be a hollow structure, which can save the material and reduce the cost.

In Embodiment 4 of the present invention, in an actual application, the first fixing part 70 and the second fixing part 80 can be replaced with each other. That is, the first fixing part 70 can be connected to the installation, and the second fixing part 80 can be connected to the installation surface.

In the embodiments of the present invention, the first fixing part can be connected to the installation surface in a punching-free manner such as adhering or fixing with a sucker. When the first fixing part is connected to the installation surface by means of adhering, e.g., using a double-sided adhesive, the double-sided adhesive can be directly disposed on the first fixing part; or the first fixing part can be separated, and is adhered to the installation surface by a double-sided adhesive only when needed. In the present invention, the adhesion layer may also be another substance that is adhesive, such as glue, which is not limited in the present invention.

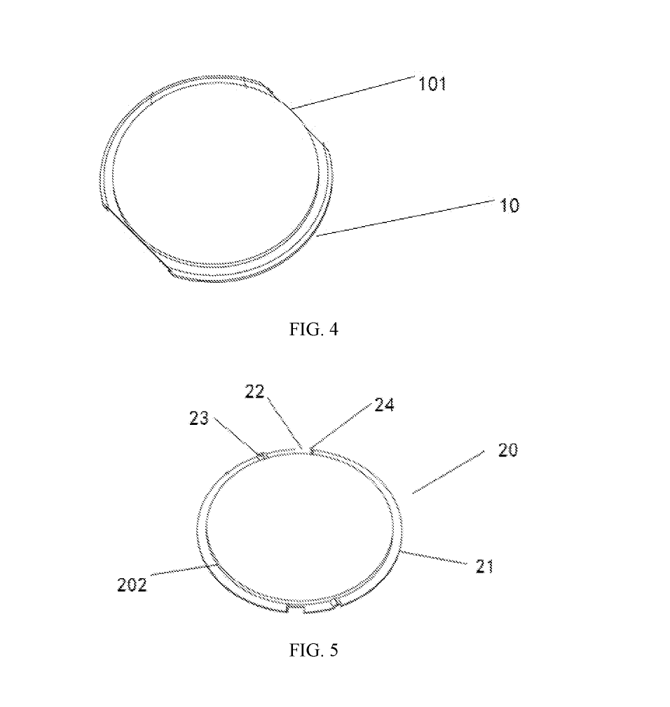

In the embodiments of the present invention, a portion of the first fixing part in contact with the installation surface is provided with an adhesion layer 101 that can be adhered to the installation surface. Referring to FIG. 4, by taking the first fixing part 10 in Embodiment 1 as an example, the adhesion layer 101 has an adhesion function and can directly adhere the first fixing part 10 onto the portion in contact with the installation surface without punching a hole on the installation surface, which can avoid damaging the installation surface and only needs to adhere the first fixing part 10 onto the installation surface. The installation manner is simple, and labor costs of the installation can be reduced.

The adhesion layer 101 may be a double-sided adhesive. One adhesive surface of the double-sided adhesive can be adhered to the first fixing part, and the other adhesive surface can be adhered to the installation surface. The adhesion layer 101 may also be another substance that is adhesive, which is not limited in the present invention.

In the embodiments of the present invention, a portion of the first fixing part in contact with the installation surface is provided with an adsorption part (not shown) that can be adsorbed on the installation surface. The installation surface is adsorbed on the first fixing part by using the adsorption part. The installation is simple, the cost can be reduced, and it is unnecessary to punch a hole on the installation surface, which can avoid the damage to the installation surface.

The adsorption part can be a sucker. An adsorption surface of the sucker corresponds to the installation surface. During installation, the adsorption surface of the sucker is attached to the installation surface, and the first fixing part is adsorbed on the installation surface through the adsorption force of the sucker, to implement installation. The sucker may be made of a rubber material, which is low in costs and easy to use.

In the embodiments of the present invention, the first fixing part is provided with at least one screw hole 102. Referring to FIG. 3, by taking the first fixing part 10 in Embodiment 1 as an example, when the material of the installation surface is not conducive to being connected to the first fixing part 10 by adhesion or adsorption with a sucker, or in order to make the connection between the first fixing part 10 and the installation surface tighter, the first fixing part 10 can be connected to the installation surface by thread by using the set screw hole 102.

In the embodiments of the present invention, the first fixing part or the second fixing part is provided with a magnet part 201. Referring to FIG. 6, by taking that the magnet part 201 is disposed on the second fixing part 20 of Embodiment 1 as an example, the first fixing part 10 and the second fixing part 20 can be made of rigid materials. By setting the magnet part 201, the first fixing part 10 and the second fixing part 20 can be adsorbed together, further strengthening the connection between the first fixing part 10 and the second fixing part 20. By setting the magnet part 201, the first fixing part 10 and the second fixing part 20 can be connected together effectively, and the structure is simple, easy to remove, and low in costs.

In the embodiments of the present invention, a contact surface between the second fixing part and the installation has an adhesion layer 202 that can be adhered with the contact surface. Referring to FIG. 5, by taking the second fixing part 20 of Embodiment 1 as an example, the adhesion layer 202 can be a double-sided adhesive, or another substance that is adhesive, which is not limited in the present invention.

In the embodiments of the present invention, the double-sided adhesive can be an EVA foam glue, which can reduce vibration and mitigate shock when an alarm operates. Effective installation can also be achieved on some uneven surfaces because of the elasticity of the EVA.

The combined fixing apparatus provided in the embodiments of the present invention detachably connects a first fixing part to a second fixing part, facilitating assembly and disassembly of installations, and fixes the first fixing part in a punching-free manner, which can avoid the damage to an installation surface and can reduce labor costs of the installation, improving the working efficiency.

Referring to FIG. 1, an alarm device provided in an embodiment of the present invention includes: an alarm 2; and a combined fixing apparatus 1 that can be fixedly connected to the alarm 2, configured to install the alarm 2 on an installation surface; wherein the combined fixing apparatus 1 includes: a first fixing part that can be fixed to the installation surface in a punching-free manner; and a second fixing part that can be fastened to an installation; wherein the first fixing part and the second fixing part are provided with detachable structures cooperating with each other and reliably connecting the first fixing part to the second fixing part respectively.

In the embodiment of the present invention, the first fixing part is detachably connected to the second fixing part, facilitating assembly and disassembly of an alarm, and the first fixing part is fixed in the punching-free manner, which can avoid the damage to the installation surface and can reduce labor costs of the installation, improving the working efficiency.

The installation surface may be an object such as a ceiling or a wall. The installation is an alarm.

In the embodiment of the present invention, the first fixing part and the second fixing part can be connected by using detachable structures, as described in detail as follows:

In Embodiment 1 of the present invention, an implementation manner in which a first fixing part 10 and a second fixing part 20 can be connected by means of clamping after rotation is provided.

Referring to FIG. 2 to FIG. 5, the first fixing part 10 includes: a first flat plate portion 11. Edges of the first flat plate portion 11 are provided with borders 12 and snaps 13 disposed on the borders 12.

In Embodiment 1 of the present invention, the first fixing part 10 further includes operable notches 14 disposed oppositely. After the second fixing part 20 is embedded into the borders 12 of the first fixing part 10, by gripping the positions of the operable notches 14 and rotating the second fixing part 20, the first fixing part 10 and the second fixing part 20 rotate relatively to form clamping.

Further, the borders 12 form two borders 12 disposed oppositely under the influences of the operable notches 14 of the first fixing part 10.

Referring to FIG. 3, FIG. 5, and FIG. 6, the second fixing part 20 includes: a second flat plate portion 21. The second flat plate portion 21 is provided with notches 22 opposite the snaps 13, such that the second flat plate portion 21 can be attached to the first flat plate portion 11 and is embedded into the borders 12, and the first fixing part 10 and the second fixing part 20 rotate relatively to form clamping.

In Embodiment 1 of the present invention, the second fixing part 20 further includes a first limit structure 23. The first limit structure 23 is disposed on a screw-in side of the second fixing part 20, and can be configured to limit the quantity of screw-in of the second fixing part 20 screwed in the borders 12 of the first fixing part 10. The first limit structure 23 is higher than the snaps 13. Therefore, when the second fixing part 20 rotates to the position where the first limit structure 23 comes into contact with the snaps 13, the first limit structure 23 can stop the snaps 13 from passing and then stop the second fixing part 20 from rotating, to form locked clamping.

In Embodiment 1 of the present invention, the second fixing part 20 further includes a second limit structure 24. The second limit structure 24 is disposed on a side opposite the screw-in side, and is formed by extending outwardly from an edge on one side of the notches 22. The second limit structure 24 is higher than the snaps 13. Therefore, when the second fixing part 20 needs to be removed from the borders 12 of the first fixing part 10, the second fixing part 20 can be rotated to the second limit structure 24, such that the notches 22 disposed on the second fixing part 20 correspond to the snaps 13 on the first fixing part 10, and the second fixing part 20 is separated from the first fixing part 10. By setting the second limit structure 24, the notches 22 can be found quickly, such that the second fixing part 20 is separated from the first fixing part 10 quickly, which is easy to disassemble.

In Embodiment 2 of the present invention, an implementation manner in which a first fixing part 30 and a second fixing part 40 can be connected by thread is provided.

Referring to FIG. 7, as an implementation manner of Embodiment 2 of the present invention, the first fixing part 30 includes a first planar member 31 and a side wall 32 that is located at an edge of the first planar member 31 and extends circumferentially towards the direction where the first fixing part 30 is connected to the second fixing part 40. An inner surface of the side wall 32 is provided with threads.

The second fixing part 40 includes a second planar member 41. An outer side wall of the second planar member 41 is provided with threads matching the threads disposed on the inner surface of the side wall 32. When it is necessary to connect the first fixing part 30 to the second fixing part 40, the outer side wall of the second planar member 41 contacts the first planar member 31 and matches the threads disposed on the side wall 32 of the first planar member 31 by means of rotation, thus connecting the first fixing part 30 to the second fixing part 40 by thread, being easy to disassemble. The fixing parts can be removed and replaced at any time, and the structure is simple, easy to install, and low in costs.

The first fixing part 30 and the second fixing part 40 provided in Embodiment 2 of the present invention can be replaced with each other. That is, the first fixing part 30 can be connected to the installation, and the second fixing part 40 can be connected to the installation surface.

In Embodiment 3 of the present invention, an implementation manner in which a first fixing part 50 and a second fixing part 60 can be connected by means of insertion and locking is provided.

Referring to FIG. 8, the first fixing part 50 includes a first flat plate structure 51, a sliding rails 52 that are disposed oppositely on two sides of the first flat plate structure 51 and extend towards a thickness direction, a baffle structure 53 configured to limit a moving distance of the second fixing part 60, and a stopping sheet 54 that is disposed on the first flat plate structure 51 and configured to lock the second fixing part after the second fixing part 60 slides into the sliding rails 52 of the first fixing part 50 and comes into contact with the baffle structure 53.

Referring to FIG. 9, the second fixing part 60 includes a second flat plate structure 61, and step structures 62 disposed oppositely on two sides of the second flat plate structure 61 and configured to slide in cooperation with the sliding rails 52.

When it is necessary to connect the second fixing part 60 to the first fixing part 50, the second fixing part 60 starts to slide along the sliding rails 52 from one side provided with the stopping sheet 54, till it slides to the position of the baffle structure 53. As the stopping sheet 54 is elastic, the stopping sheet 54 will be compressed to a horizontal state under the action of the second fixing part 60 when the second fixing part 60 passes, and resumes the original state when the second fixing part 60 passes completely. In this case, the stopping sheet 54 is attached to one side of the second fixing part 60, and the second fixing part 60 is fixed between the stopping sheet 54 and the baffle structure 53, thus connecting the first fixing part 50 and the second fixing part 60.

In Embodiment 3 of the present invention, in an actual application, the first fixing part 50 and the second fixing part 60 can be replaced with each other. That is, the first fixing part 50 can be connected to the installation, and the second fixing part 60 can be connected to the installation surface.

In Embodiment 4 of the present invention, an implementation manner in which a first fixing part 70 and a second fixing part 80 can be connected by means of clamping is provided.

Referring to FIG. 10, in Embodiment 4 of the present invention, the first fixing part 70 includes: a platform structure 71. A side wall of the platform structure 71 is provided with a snap ring 72. The second fixing part 80 includes an accommodating slot 81. The accommodating slot 81 can accommodate the platform structure 71, and is clamped together with the platform structure 71 by using the snap ring 72.

The platform structure 71 can be a hollow structure, which can save the material and reduce the cost.

In Embodiment 4 of the present invention, in an actual application, the first fixing part 70 and the second fixing part 80 can be replaced with each other. That is, the first fixing part 70 can be connected to the installation, and the second fixing part 80 can be connected to the installation surface.

In the embodiments of the present invention, the first fixing part can be connected to the installation surface in a punching-free manner such as adhering or fixing with a sucker. When the first fixing part is connected to the installation surface by means of adhering, e.g., using a double-sided adhesive, the double-sided adhesive can be directly disposed on the first fixing part; or the first fixing part can be separated, and is adhered to the installation surface by a double-sided adhesive only when needed. In the present invention, the adhesion layer may also be another substance that is adhesive, such as glue, which is not limited in the present invention.

In the embodiments of the present invention, a portion of the first fixing part in contact with the installation surface is provided with an adhesion layer 101 that can be adhered to the installation surface. Referring to FIG. 4, by taking the first fixing part 10 in Embodiment 1 as an example, the adhesion layer 101 has an adhesion function and can directly adhere the first fixing part 10 onto the portion in contact with the installation surface without punching a hole on the installation surface, which can avoid damaging the installation surface and only needs to adhere the first fixing part 10 onto the installation surface. The installation manner is simple, and labor costs of the installation can be reduced.

The adhesion layer 101 may be a double-sided adhesive. One adhesive surface of the double-sided adhesive can be adhered to the first fixing part, and the other adhesive surface can be adhered to the installation surface. The adhesion layer 101 may also be another substance that is adhesive, which is not limited in the present invention.

In the embodiments of the present invention, a portion of the first fixing part in contact with the installation surface is provided with an adsorption part (not shown) that can be adsorbed on the installation surface. The installation surface is adsorbed on the first fixing part by using the adsorption part. The installation is simple, the cost can be reduced, and it is unnecessary to punch a hole on the installation surface, which can avoid the damage to the installation surface.

The adsorption part can be a sucker. An adsorption surface of the sucker corresponds to the installation surface. During installation, the adsorption surface of the sucker is attached to the installation surface, and the first fixing part is adsorbed on the installation surface through the adsorption force of the sucker, to implement installation. The sucker may be made of a rubber material, which is low in costs and easy to use.

In the embodiments of the present invention, the first fixing part is provided with at least one screw hole 102. Referring to FIG. 3, by taking the first fixing part 10 in Embodiment 1 as an example, when the material of the installation surface is not conducive to being connected to the first fixing part 10 by adhesion or adsorption with a sucker, or in order to make the connection between the first fixing part 10 and the installation surface tighter, the first fixing part 10 can be connected to the installation surface by thread by using the set screw hole 102.

In the embodiments of the present invention, the first fixing part or the second fixing part is provided with a magnet part 201. Referring to FIG. 6, by taking that the magnet part 201 is disposed on the second fixing part 20 of Embodiment 1 as an example, the first fixing part 10 and the second fixing part 20 can be made of rigid materials. By setting the magnet part 201, the first fixing part 10 and the second fixing part 20 can be adsorbed together, further strengthening the connection between the first fixing part 10 and the second fixing part 20. By setting the magnet part 201, the first fixing part 10 and the second fixing part 20 can be connected together effectively, and the structure is simple, easy to remove, and low in costs.

In the embodiments of the present invention, a contact surface between the second fixing part and the installation has an adhesion layer 202 that can be adhered with the contact surface. Referring to FIG. 5, by taking the second fixing part 20 of Embodiment 1 as an example, the adhesion layer 202 can be a double-sided adhesive, or another substance that is adhesive, which is not limited in the present invention.

In the embodiments of the present invention, the double-sided adhesive can be an EVA foam glue, which can reduce vibration and mitigate shock when an alarm operates. Effective installation can also be achieved on some uneven surfaces because of the elasticity of the EVA.

According to the alarm device provided in the present invention, an alarm is installed on an installation surface in a punching-free manner by using a combined fixing apparatus, which can avoid the damage to the installation surface and can reduce labor costs of installation, improving the working efficiency. Moreover, a first fixing part and a second fixing part of the combined fixing apparatus are connected detachably, which facilitates assembly and disassembly of the alarm. The structure is simple and easy to operate.

The above descriptions are merely preferred embodiments of the present invention, which are not used to limit the present invention. Any modification, equivalent replacement, improvement and the like made within the spirit and principle of the present invention should all be encompassed in the protection scope of the present invention.

1. A combined fixing apparatus, wherein the apparatus comprises:
a first fixing part that can be fixed to an installation surface in a punching-free manner; and
a second fixing part that can be fastened to an installation;
wherein the first fixing part and the second fixing part are provided with detachable structures cooperating with each other and reliably connecting the first fixing part to the second fixing part respectively.

2. The combined fixing apparatus according to claim 1, wherein a portion of the first fixing part in contact with the installation surface is provided with an adhesion layer that can be adhered with the installation surface.

3. The combined fixing apparatus according to claim 1, wherein a portion of the first fixing part in contact with the installation surface is provided with an adsorption part that can be adsorbed on the installation surface.

4. The combined fixing apparatus according to claim 1, wherein the first fixing part is provided with at least one screw hole.

5. The combined fixing apparatus according to claim 1, wherein the first fixing part or the second fixing part is provided with a magnet part.

6. The combined fixing apparatus according to claim 1, wherein the first fixing part and the second fixing part can be connected by means of clamping after rotation.

7. The combined fixing apparatus according to claim 1, wherein the first fixing part and the second fixing part can be connected by thread.

8. The combined fixing apparatus according to claim 1, wherein the first fixing part and the second fixing part can be connected by means of insertion and locking.

9. An alarm device, wherein the alarm device comprises:
an alarm; and
a combined fixing apparatus that can be fixedly connected to the alarm, configured to install the alarm on an installation surface;
wherein the combined fixing apparatus comprises:
a first fixing part that can be fixed to the installation surface in a punching-free manner; and
a second fixing part that can be fastened to an installation;
wherein the first fixing part and the second fixing part are provided with detachable structures cooperating with each other and reliably connecting the first fixing part to the second fixing part respectively.

10. The alarm device according to claim 9, wherein a portion of the first fixing part in contact with the installation surface is provided with an adhesion layer that can be adhered with the installation surface.

11. The alarm device according to claim 9, wherein a portion of the first fixing part in contact with the installation surface is provided with an adsorption part that can be adsorbed on the installation surface.

12. The alarm device according to claim 9, wherein the first fixing part is provided with at least one screw hole.

13. The alarm device according to claim 9, wherein the first fixing part or the second fixing part is provided with a magnet part.

14. The alarm device according to claim 9, wherein the first fixing part and the second fixing part can be connected by means of clamping after rotation.

15. The alarm device according to claim 9, wherein the first fixing part and the second fixing part can be connected by thread.

16. The alarm device according to claim 9, wherein the first fixing part and the second fixing part can be connected by means of insertion and locking.
